(19) United States
(12) Patent Application Publication
(10) Pub. No.: US 2024/0353684 A1
(43) Pub. Date: Oct. 24, 2024

(54) Waveguided Display Systems with Dynamic Tinting

(71) Applicant: Apple Inc., Cupertino, CA (US)

(72) Inventors: Runyu Zhang, Santa Clara, CA (US); Vikrant Bhakta, Santa Clara, CA (US); Hyungryul Choi, San Jose, CA (US); Cameron A. Harder, San Francisco, CA (US); Xiaonan Wen, San Jose, CA (US); Zhenbin Ge, San Jose, CA (US); Xianwei Zhao, Cupertino, CA (US)

(21) Appl. No.: 18/756,771

(22) Filed: Jun. 27, 2024

Related U.S. Application Data
(63) Continuation of application No. PCT/US23/60171, filed on Jan. 5, 2023.
(60) Provisional application No. 63/298,873, filed on Jan. 12, 2022.

(51) Int. Cl. G02B 27/01

(52) U.S. Cl. CPC G02B 27/0172; G02B 2027/0118; G02B 2027/0174

(57) ABSTRACT

A display system may include a waveguide with an output coupler that couples image light out of the waveguide and towards an eye box. The output coupler may also transmit world light from real-world objects towards the eye box. A bias lens may pass the world light to the output coupler. An adjustable tint layer having multiple states that involve transmission of different amounts of the world light may be disposed between the bias lens and the output coupler. Different states may impart different colors and/or may impart a gradient transmission characteristic to the world light. The bias lens itself may form the adjustable tint layer. The adjustable tint layer may have a transparent electrode layer that is provided with one or more AC voltages that heat the adjustable tint layer. The adjustable tint layer may be a self-switching electrochromic device that includes a transparent solar cell.

This application is a continuation of international patent application No. PCT/US2023/060171, filed Jan. 5, 2023, which claims the benefit of U.S. provisional patent application No. 63/298,873, filed Jan. 12, 2022, which are hereby incorporated by reference herein in their entireties.

### BACKGROUND

This disclosure relates generally to optical systems and, more particularly, to optical systems for electronic devices with displays. Devices such as these can be challenging to design. If care is not taken, the components used to display images in these devices may not exhibit a desired optical performance.

### SUMMARY

An electronic device may have a display system. The display system may include a display module that provides image light to a waveguide. The waveguide may propagate the image light via total internal reflection. An output coupler may couple the image light out of the waveguide and towards an eye box. The output coupler may also transmit world light from real-world objects in front of the display system.

A bias lens may pass the world light to the output coupler while imparting an optical power onto the world light. An electrically adjustable light modulator may be interposed between the bias lens and the output coupler. The electrically adjustable light modulator may be an adjustable tint layer having multiple states that each involve transmission of a different amount of the world light to the output coupler. Different states may, if desired, impart different colors to the world light and/or may impart a gradient transmission characteristic to the world light. Different states may be used to mitigate different colorblindness characteristics if desired.

The adjustable tint layer may be layered onto the bias lens, may be separated from the bias lens by an air gap, may be separated from a cover layer for the waveguide by an air gap, may be layered onto the cover layer, or may form the cover layer itself. If desired, the bias lens itself may form the adjustable tint layer. The adjustable tint layer may have a transparent electrode layer that is provided with one or more AC voltages that heat the adjustable tint layer. Different AC voltages may be applied to provide uniform heating. Heating the adjustable tint layer may maximize switching speed and/or perform defogging. The adjustable tint layer may be a self-switching electrochromic device that includes a transparent solar cell if desired.

### BRIEF DESCRIPTION OF THE DRAWINGS

FIG. 1 is a diagram of an illustrative system having a display in accordance with some embodiments.

FIG. 2 is a top view of an illustrative optical system for a display having a waveguide with an optical coupler and bias lenses in accordance with some embodiments.

FIG. 3 is a cross-sectional side view of an illustrative optical system having a waveguide and having an adjustable tint layer on a bias lens in accordance with some embodiments.

FIG. 4 is a cross-sectional side view of an illustrative optical system having a waveguide and having an adjustable tint layer separated from a bias lens by an air gap in accordance with some embodiments.

FIG. 5 is a cross-sectional side view of an illustrative optical system having a waveguide and having an adjustable tint layer on a cover layer for the waveguide in accordance with some embodiments.

FIG. 6 is a cross-sectional side view of an illustrative optical system having a waveguide and having an adjustable tint layer that forms a cover layer for the waveguide in accordance with some embodiments.

FIG. 7 is a cross-sectional side view of an illustrative optical system having a waveguide and having adjustable tint layers that form bias lenses in accordance with some embodiments.

FIG. 8 is a front view showing how an illustrative adjustable tint layer may be transitioned between clear, uniform dark, and gradient dark states in accordance with some embodiments.

FIGS. 9-11 are cross-sectional side views showing how an illustrative adjustable tint layer may include multiple layers that can be controlled to provide different color tints to transmitted light in accordance with some embodiments.

FIG. 12 is a state diagram showing how an illustrative adjustable tint layer may be transitioned between different states that impart different characteristics to transmitted light in accordance with some embodiments.

FIG. 13 includes plots of eye response as a function of wavelength showing how an illustrative adjustable tint layer may be transitioned between different states that compensate for different types of color blindness in accordance with some embodiments.

FIG. 14 is a cross-sectional side view of an illustrative adjustable tint layer that is transitioned between different states using a DC voltage in accordance with some embodiments.

FIG. 15 is a front view showing how an illustrative adjustable tint layer that is transitioned between different states using a DC voltage may be heated using an AC voltage in accordance with some embodiments.

FIG. 16 is a front view of an illustrative adjustable tint layer that is provided with multiple AC voltages to uniformly heat the surface area of the adjustable tint layer in accordance with some embodiments.

FIG. 17 is a cross-sectional side view of an illustrative self-switching adjustable tint layer that is powered using solar light in accordance with some embodiments.

### DETAILED DESCRIPTION

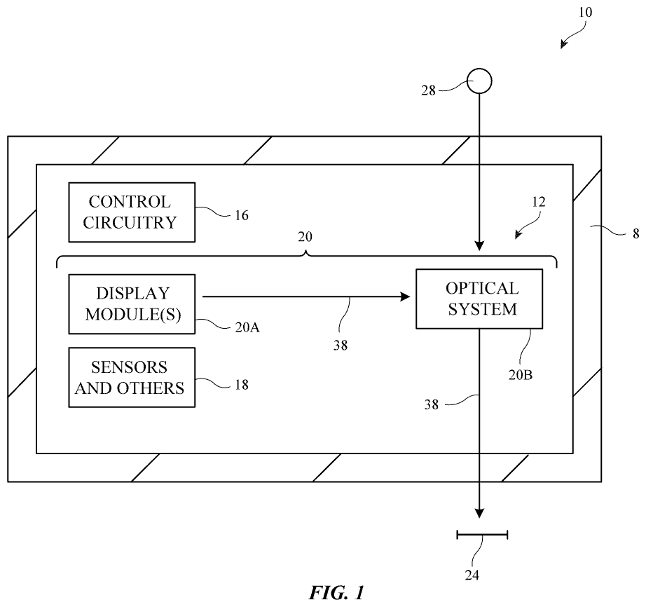

System 10 of FIG. 1 may be a head-mounted device (e.g., an electronic device) having one or more displays. The displays in system 10 may include near-eye displays 20 mounted within support structure (housing) 8. Support structure 8 may have the shape of a pair of eyeglasses or goggles (e.g., supporting frames), may form a housing having a helmet shape, or may have other configurations to help in mounting and securing the components of near-eye displays 20 on the head or near the eye of a user. Near-eye displays 20 may include one or more display modules such as display modules 20A and one or more optical systems such as optical systems 20B. Display modules 20A may be mounted in a support structure such as support structure 8. Each display module 20A may emit light 38 (image light) that is redirected towards a user's eyes at eye box 24 using an associated one of optical systems 20B.

The operation of system 10 may be controlled using control circuitry 16. Control circuitry 16 may include storage and processing circuitry for controlling the operation of system 10. Circuitry 16 may include storage such as hard disk drive storage, nonvolatile memory (e.g., electrically-programmable-read-only memory configured to form a solid state drive), volatile memory (e.g., static or dynamic random-access-memory), etc. Processing circuitry in control circuitry 16 may be based on one or more microprocessors, microcontrollers, digital signal processors, baseband processors, power management units, audio chips, graphics processing units, application specific integrated circuits, and other integrated circuits. Software code may be stored on storage in circuitry 16 and run on processing circuitry in circuitry 16 to implement operations for system 10 (e.g., data gathering operations, operations involving the adjustment of components using control signals, image rendering operations to produce image content to be displayed for a user, etc.).

System 10 may include input-output circuitry such as input-output devices 12. Input-output devices 12 may be used to allow data to be received by system 10 from external equipment (e.g., a tethered computer, a portable device such as a handheld device or laptop computer, or other electrical equipment) and to allow a user to provide head-mounted device 10 with user input. Input-output devices 12 may also be used to gather information on the environment in which system 10 (e.g., head-mounted device 10) is operating. Output components in devices 12 may allow system 10 to provide a user with output and may be used to communicate with external electrical equipment. Input-output devices 12 may include sensors and other components 18 (e.g., image sensors for gathering images of real-world object that are digitally merged with virtual objects on a display in system 10, accelerometers, depth sensors, light sensors, haptic output devices, speakers, batteries, wireless communications circuits for communicating between system 10 and external electronic equipment, etc.). In some implementations that are described herein as examples, sensors and other components 18 may include an image sensor (camera) and/or an ambient light sensor that senses the amount of ambient light for system 10 (e.g., whether system 10 is located in a dark room, a bright room, outside, etc.). These sensors may provide sensor signals to control circuitry 16. Control circuitry 16 may adjust one or more components in optical system 20B such as one or more adjustable tint layers in optical system 20B based on the sensor signals.

Display modules 20A may be liquid crystal displays, organic light-emitting diode displays, laser-based displays, or displays of other types (e.g., reflective displays that include one or more digital micromirror device (DMD) panels and/or liquid crystal on silicon (LCOS) panels etc.). Display modules 20A may sometimes be referred to herein as display projectors 20A, light projectors 20A, image projectors 20A, or projectors 20A. Optical systems 20B may include lenses that allow a viewer (see, e.g., a viewer's eyes at eye box 24) to view images on display(s) 20. There may be two optical systems 20B (e.g., for forming left and right lenses) associated with respective left and right eyes of the user. A single display 20 may produce images for both eyes or a pair of displays 20 may be used to display images. In configurations with multiple displays (e.g., left and right eye displays), the focal length and positions of the lenses formed by system 20B may be selected so that any gap present between the displays will not be visible to a user (e.g., so that the images of the left and right displays overlap or merge seamlessly).

If desired, optical system 20B may contain components (e.g., an optical combiner, etc.) to allow real-world image light from real-world images or objects 28 to be combined optically with virtual (computer-generated) images such as virtual images in image light 38. In this type of system, which is sometimes referred to as an augmented reality system, a user of system 10 may view both real-world content and computer-generated content that is overlaid on top of the real-world content. Camera-based augmented reality systems may also be used in device 10 (e.g., in an arrangement in which a camera captures real-world images of object 28 and this content is digitally merged with virtual content at optical system 20B).

System 10 may, if desired, include wireless circuitry and/or other circuitry to support communications with a computer or other external equipment (e.g., a computer that supplies display 20 with image content). During operation, control circuitry 16 may supply image content to display 20. The content may be remotely received (e.g., from a computer or other content source coupled to system 10) and/or may be generated by control circuitry 16 (e.g., text, other computer-generated content, etc.). The content that is supplied to display 20 by control circuitry 16 may be viewed by a viewer at eye box 24 (e.g., in image light 38). Image light 38 may be, for example, light that contains and/or represents something viewable such as a scene or object (e.g., as modulated onto the image light using the image data provided by the control circuitry to the display module).

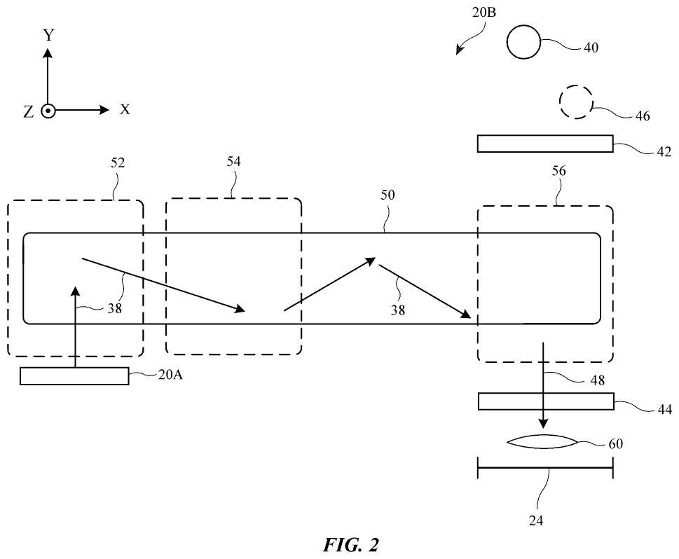

FIG. 2 is a top view of an illustrative display that may be used in system 10 of FIG. 1 (e.g., as display 20 of FIG. 1). As shown in FIG. 2, the display may include one or more display modules such as display module(s) 20A and an optical system such as optical system 20B. Optical system 20B may include optical elements such as one or more waveguides 50. Waveguide 50 may include one or more stacked substrates (e.g., stacked planar and/or curved layers sometimes referred to herein as waveguide substrates) of optically transparent material such as plastic, polymer, glass, etc.

If desired, waveguide 50 may also include one or more layers of holographic recording media (sometimes referred to herein as holographic media, grating media, or diffraction grating media) on which one or more diffractive gratings are recorded (e.g., holographic phase gratings, sometimes referred to herein as holograms). A holographic recording may be stored as an optical interference pattern (e.g., alternating regions of different indices of refraction) within a photosensitive optical material such as the holographic media. The optical interference pattern may create a holographic phase grating that, when illuminated with a given light source, diffracts light to create a three-dimensional reconstruction of the holographic recording. The holographic phase grating may be a non-switchable diffractive grating that is encoded with a permanent interference pattern or may be a switchable diffractive grating in which the diffracted light can be modulated by controlling an electric field applied to the holographic recording medium. Multiple holographic phase gratings (holograms) may be recorded within (e.g., superimposed within) the same volume of holographic medium if desired. The holographic phase gratings may be, for example, volume holograms or thin-film holograms in the grating medium. The grating media may include photopolymers, gelatin such as dichromated gelatin, silver halides, holographic polymer dispersed liquid crystal, or other suitable holographic media.

Diffractive gratings on waveguide 50 may include holographic phase gratings such as volume holograms or thin-film holograms, meta-gratings, or any other desired diffractive grating structures. The diffractive gratings on waveguide 50 may also include surface relief gratings (SRGs) formed on one or more surfaces of the substrates, gratings formed from patterns of metal structures, etc. The diffractive gratings may, for example, include multiple multiplexed gratings (e.g., holograms) that at least partially overlap within the same volume of grating medium (e.g., for diffracting different colors of light and/or light from a range of different input angles at one or more corresponding output angles). Other light redirecting elements such as louvered mirrors may be used in place of diffractive gratings in waveguide 50 if desired.

As shown in FIG. 2, display module 20A may generate image light 38 associated with image content to be displayed to eye box 24. Image light 38 may be collimated using a collimating lens if desired. Optical system 20B may be used to present image light 38 output from display module 20A to eye box 24. If desired, display module 20A may be mounted within support structure 8 of FIG. 1 while optical system 20B may be mounted between portions of support structure 8 (e.g., to form a lens that aligns with eye box 24). Other mounting arrangements may be used, if desired.

Optical system 20B may include one or more optical couplers (e.g., light redirecting elements) such as input coupler 52, cross-coupler 54, and output coupler 56. In the example of FIG. 2, input coupler 52, cross-coupler 54, and output coupler 56 are formed at or on waveguide 50. Input coupler 52, cross-coupler 54, and/or output coupler 56 may be completely embedded within the substrate layers of waveguide 50, may be partially embedded within the substrate layers of waveguide 50, may be mounted to waveguide 50 (e.g., mounted to an exterior surface of waveguide 50), etc.

Waveguide 50 may guide image light 38 down its length via total internal reflection. Input coupler 52 may be configured to couple image light 38 from display module 20A into waveguide 50, whereas output coupler 56 may be configured to substantially couple image light 38 (e.g., all or a substantial amount of image light 38) from within waveguide 50 to the exterior of waveguide 50 and towards eye box 24 (as shown by light 48). Input coupler 52 may include an input coupling prism, an edge or face of waveguide 50, a lens, a steering mirror or liquid crystal steering element, or any other desired input coupling elements. As an example, display module 20A may emit image light 38 in direction +Y towards optical system 20B. When image light 38 strikes input coupler 52, input coupler 52 may redirect image light 38 so that the light propagates within waveguide 50 via total internal reflection towards output coupler 56 (e.g., in direction +X within the total internal reflection (TIR) range of waveguide 50). When image light 38 strikes output coupler 56, output coupler 56 may redirect image light 38 out of waveguide 50 towards eye box 24 (e.g., back along the Y-axis). A lens such as lens 60 may help to direct or focus image light 38 onto eye box 24. Lens 60 may be omitted if desired. In scenarios where cross-coupler 54 is formed on waveguide 50, cross-coupler 54 may redirect image light 38 in one or more directions as it propagates down the length of waveguide 50, for example. In redirecting image light 38, cross-coupler 54 may also perform pupil expansion on image light 38.

Input coupler 52, cross-coupler 54, and/or output coupler 56 may be based on reflective and refractive optics or may be based on diffractive (e.g., holographic) optics. In arrangements where couplers 52, 54, and 56 are formed from reflective and refractive optics, couplers 52, 54, and 56 may include one or more reflectors (e.g., an array of micromirrors, partial mirrors, louvered mirrors, or other reflectors). In arrangements where couplers 52, 54, and 56 are based on diffractive optics, couplers 52, 54, and 56 may include diffractive gratings (e.g., volume holograms, surface relief gratings, etc.).

The example of FIG. 2 is merely illustrative. Optical system 20B may include multiple waveguides that are laterally and/or vertically stacked with respect to each other. Each waveguide may include one, two, all, or none of couplers 52, 54, and 56. Waveguide 50 may be at least partially curved or bent if desired. One or more of couplers 52, 54, and 56 may be omitted.

As shown in FIG. 2, waveguide 50 and output coupler 56 may be mounted between an outer optical element such as outer lens 42 and an inner optical element such as inner lens 44. Lenses 42 and 44 may be formed from glass or polymer, as examples. Inner lens 44 may have a negative bias component and/or a user-specific eyeglass prescription component. Inner lens 44 may therefore sometimes be referred to herein as negative bias lens 44, prescription lens 44, or simply as lens 44. Outer lens 42 may have a positive bias component that is equal and opposite to that of the negative bias component. Outer lens 42 may therefore sometimes be referred to herein as positive bias lens 42 or simply as lens 42. As one example, outer lens 42 may have a +1 diopter bias component and inner lens 44 may have a −1 diopter bias component. When viewing real-world images from eye box 24 through the optical systems formed from lenses 42 and 44 and waveguide 50, these two bias components cancel each other. If a user has a vision defect (e.g., nearsightedness or farsightedness), vision correction can be implemented by combining a user's prescription with the negative bias component of inner lens 44. Otherwise, inner lens 44 may include only the negative bias component.

Consider, as an example, a scenario in which a user is nearsighted and has a prescription dictating the use of −0.5 diopter of vision correction. In this situation, the vision correction component of lens 44 will be −0.5. When combined with the −1.0 diopter of the negative bias component, the lens power of inner lens 44 (in this example) will be −1.5 diopter.

Display images that have been coupled into waveguide 50 are coupled out of waveguide 50 towards eye box 24 by output coupler 56, as shown by light 48. The display images in light 48 pass through the negative bias of inner lens 44, which places the display images at a desired virtual image distance. This virtual image distance is one meter in the illustrative situation where the negative bias of lens 44 is −1 diopter. The vision correction component of lens 44 (which is −0.5 diopter for the illustrative user in the present example) is used to correct for the user's nearsightedness. In general, the vision correction component of lens 44 may be used to correct for farsightedness, nearsightedness, astigmatism, etc.

The presence of a lens power in outer lens 42 that is equal and opposite to the negative bias component of lens 44 compensates for the presence of the negative bias lens power in inner lens 44 when a user is viewing real-world objects (e.g., world light emitted and/or reflected by the real-world objects). This is because the +1 diopter bias of lens 42 and the −1.0 diopter bias of lens 44 cancel each other so no lens power is imposed on real-world image light that passes through lens 42, waveguide 50, and lens 44 to eye box 24.

The optical systems for the user's left and right eyes (sometimes referred to as eyeglass lenses, optical combiner systems, etc.) may include optical component layers. For example, a fixed light absorbing layer (sometimes referred to as a fixed tint layer) may be formed from a polymer film containing dye and/or pigment (as an example). A tint layer of this type may be mounted on or adjacent to the inner or outer surface of lens 42 (as an example) to help reduce the brightness of real-world objects such as object 40 (e.g., world light from object 40) so that the intensity of real-world image light does not overwhelm the intensity of image light from display module 20A that is used in producing virtual image 46 (e.g., within the light 48 provided to eye box 24).

If desired, light absorbing layer(s) in device 10 or other optical component(s) may be adjustable. These adjustable optical components may include adjustable layers that are controlled by control signals from control circuitry 12. As an example, an electrically adjustable tint layer (sometimes referred to as an electrically adjustable light modulator or electrically adjustable light modulator layer) may be formed from an organic or inorganic electrochromic light modulator layer or a guest-host liquid crystal light modulator layer. The adjustable tint layer may be formed from structures located between output coupler 56 and lens 42 and/or may be located on the externally facing side of lens 42. During operation of device 10, the electrically adjustable tint layer may be dynamically placed in a high transmission mode (sometimes referred to herein as a clear state) when it is desired to enhance the visibility of real-world objects or in a lower transmission mode (sometimes referred to herein as a dark state) when it is desired to reduce scene brightness and thereby help enhance the viewability of image light from display module 20A (e.g., to allow virtual objects such as virtual objects in virtual image 46 to be viewed without being overwhelmed by bright environmental light).

Other electrically adjustable optical components may also be provided for device 10, if desired. These components may include, for example, electrically adjustable polarizer layers such as adjustable polarizers based on liquid crystals, electrically adjustable light reflectors such as adjustable cholesteric liquid crystal layers, electrically adjustable color cast layers such a color cast adjustment layers based on guest-host liquid crystals, adjustable haze layers based on polymer dispersed liquid crystal layers, and/or other electrically adjustable optical layers. In an illustrative configuration, which may sometimes be described herein as an example, the left and right eyeglass lenses of device 10 may be provided with adjustable tint layers (e.g., adjustable light modulator layers such as electrochromic layers, guest-host liquid crystal layers, or other layers configured to exhibit adjustable light transmission). The adjustable tint layers may be used in bright ambient lighting conditions to temporarily decrease the amount of real-world light from objects such as object 40 that reaches eye box 24. This reduces scene brightness and thereby allows display image light from waveguide 50 to be viewed at eye box 24 without being overwhelmed and thereby washed out by overly bright real-world image light.

Adjustable tint layers (or other fixed and/or adjustable optical layers) may be attached to the inner and/or outer surfaces of some or all parts of optical components such as lenses 44, lenses 42, and/or waveguide 50. To reduce the weight and/or size of device 10, it may be desirable to form adjustable tint components and/or other optical components using transparent substrate structures (transparent layers) that form parts of lenses 42, lenses 44, and/or waveguide 50.

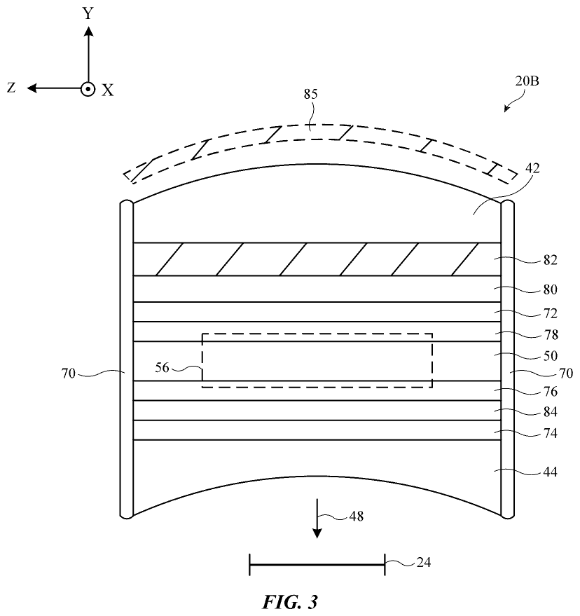

FIG. 3 is a cross-sectional side view showing one example of how an adjustable optical component such as an adjustable tint layer may be integrated into optical system 20B. As shown in FIG. 3, optical system 20B may include head-mounted support structure 70 (e.g., part of support structure 8 of FIG. 1) to house the components of system 10 and to support system 10 on a user's head. Support structure 70 may include, for example, structures that form housing walls and other structures at the front of system 10 (sometimes referred to as a frame, a lens support frame, a glasses frame, etc.). In particular, support structure 70 may include support structures at the front of device 10, which form glasses frame structures such as a nose bridge, a frame portion that supports left and right lenses with embedded waveguides, and/or other housing structures. Support structure 70 may also include additional structures such as straps, glasses side frame structures such as glasses arms (temples), or other supplemental support structures that help to hold the frame and the components in the frame on a user's face so that the user's eyes are located within eye boxes 24. If desired, support structure 70 may include hinges (e.g., so that the arms of system 10 can be folded parallel to the frame at the front of device 10 when not in use).

As shown in FIG. 3, waveguide 50, one or more waveguide cover layers such as cover layer 72 and cover layer 84 (e.g., cover glass layers), outer lens 42, and inner lens 44 may be mounted to support structure 70. Cover layer 72 may be separated from waveguide 50 by air gap 78 and/or cover layer 84 may be separated from waveguide 50 by air gap 76 if desired. Air gaps 78 and 76 may preserve total internal reflection of the image light within waveguide 50, for example. If desired, optical system 20B may include one or more peripheral adhesive seals (e.g., rings of adhesive) that seal the air gaps of optical system 20B from the outside environment while attaching the components of optical system 20B to support structure 70.

Waveguide 50 may include output coupler 56. Output coupler 56 may couple the image light propagating within waveguide 50 (e.g., image light 38 of FIG. 2) out of waveguide 50 and towards eye box 24 through lens 44 (as light 48). Light 48 may also include light from real-world objects in front of system 10 (e.g., object 40 of FIG. 2). In examples where output coupler 56 includes one or more holograms (e.g., volume holograms), waveguide 50 may include one or more waveguide substrates that sandwich a grating medium layer in which the holograms are recorded. Cover layers 72 and/or 84 may be omitted in these examples if desired. In examples where output coupler 56 includes one or more surfaced relief gratings, waveguide 50 may include a surface relief grating substrate. Surface relief gratings may be formed (e.g., etched or cut) into one or both the lateral surfaces of the surface relief grating substrate (e.g., facing lens 42 and/or facing lens 44). Cover layers 72 and 84 may serve to protect the micro-structure of the surface relief gratings from damage or contaminants, for example.

Optical system 20B may include an electrically adjustable optical component such as adjustable tint layer 82. Adjustable tint layer 82 may include one or more substrates and one or more layers of electrically adjustable tint material (e.g., sandwiched between the substrates). The adjustable tint material may include an organic electrochromic (EC) material, an inorganic electrochromic material, or a guest-host liquid crystal layer, as examples. Adjustable tint layer 82 may include two or more electrodes formed from transparent conductive layers (e.g., layers of indium tin oxide (ITO) or other transparent conductive coating material). The electrodes may receive control signals from control circuitry 16 (FIG. 1).

The control circuitry may adjust the voltage of the control signals provided across the terminals of the electrodes to change the electric field applied by the electrodes to the layer of tint material, thereby adjusting the amount of light transmission exhibited by the layer of tint material. In an illustrative configuration, the layer of tint material may exhibit a variable amount of light transmission ranging continuously between a minimum level of TMIN and a maximum level of TMAX. The value of TMIN may be 5%, 10%, 15%, 20%, 2-15%, 3-25%, 5-40%, 10-30%, 10-25%, at least 3%, at least 6%, at least 15%, at least 20%, less than 35%, less than 25%, less than 15%, or other suitable minimum level sufficient to help reduce environmental (real-world) light during viewing of computer-generated images from display modules 20A in bright environmental lighting conditions (e.g., in a dark state of adjustable tint layer 82). The value of TMAX may be at least 50%, at least 60%, 60-99%, 40-99.9%, 80-99%, 70-99%, 80-97%, at least 70%, at least 80%, at least 85%, at least 90%, at least 95%, less than 99.99%, less than 99%, or other suitable maximum level sufficiently transparent to allow a viewer to comfortably view real world objects through layer 82 during situations where display modules 20A are not supplying images or other situations where higher transmission levels are desirable (e.g., in a clear state of adjustable tint layer 82). The layer of tint material may be referred to herein as blocking world light from passing to the output coupler when set to exhibit transmission level TMIN or any other desired transmission level less than TMAX.

In the example of FIG. 3, adjustable tint layer 82 is mounted to lens 42 (e.g., adjustable tint layer 82 may be layered onto the inner surface of lens 42). Adjustable tint layer 82 may be separated from cover layer 72 by air gap 80. This is merely illustrative. In other arrangements, adjustable tint layer 82 may be layered onto the outer surface of lens 42.

If desired, additional layer(s) of tint material may be disposed at one or more locations within optical system 20B (e.g., overlapping adjustable tint layer 82 and output coupler 56). As one example, an additional fixed or electrically adjustable tint layer may be layered onto the outer surface of lens 42. If desired, a removable tint layer such as removable tint layer 85 may be mounted at, adjacent to, or onto the outer surface of lens 42 (e.g., at a position overlapping adjustable tint layer 82 and output coupler 56). Removable tint layer 85 may be an electrically adjustable tint layer (e.g., an adjustable tint layer such as adjustable tint layer 82) or may be a fixed tint layer having fixed light transmission characteristics. Removable tint layer 85 may be attached, affixed, adhered, clipped onto, or otherwise secured to support structure 70 or other support structures for system 10. Removable tint layer 85 may be added by a user of system 10 who wishes to add tinting functionality to system 10, for example. If desired, adjustable tint layer 82 may be omitted in scenarios where removable tint layer 85 is attachable to support structure 70. A user of system 10 may swap out removable tint layer 85 for other removable tint layers having different tinting characteristics or may simply remove tint layer 85 to remove the tinting characteristics of the tint layer from system 10. Removable tint layer 85 may be omitted if desired.

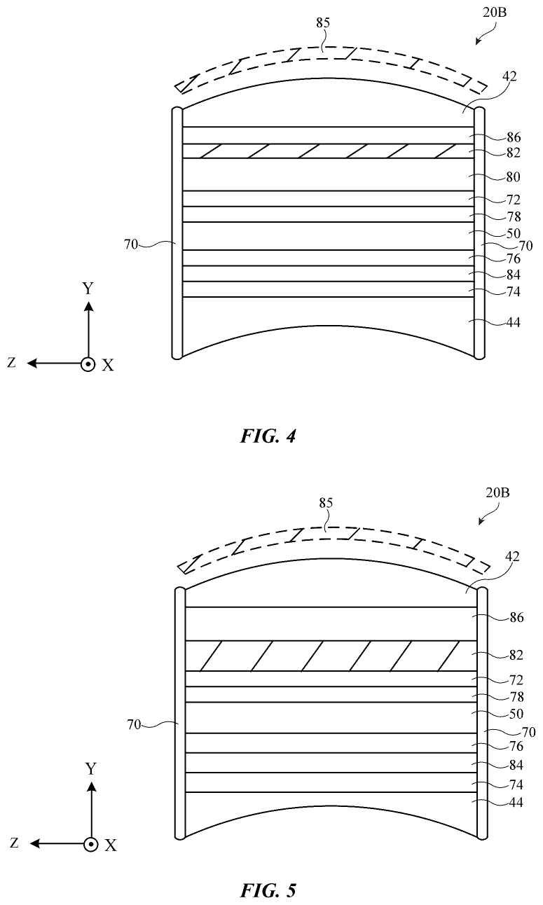

The example of FIG. 3 in which adjustable tint layer 82 is layered directly onto the inner surface of lens 42 is merely illustrative. If desired, adjustable tint layer 82 may be disposed between waveguide 50 and lens 42 with an air gap interposed between the adjustable tint layer and lens 42. FIG. 4 is a cross-sectional side view showing one example of how adjustable tint layer 82 may be disposed between waveguide 50 and lens 42 with an intervening air gap interposed between the adjustable tint layer and lens 42.

As shown in FIG. 4, adjustable tint layer 82 may be mounted to support structure 70 between lens 42 and cover layer 72 (or waveguide 50 in examples where cover layer 72 is omitted). An air gap such as air gap 86 may be interposed between adjustable tint layer 82 and lens 42 (e.g., such that adjustable tint layer 82 does not touch lens 42). When disposed in this way, air gap 80 remains interposed between adjustable tint layer 82 and cover layer 72. This example is merely illustrative. If desired, adjustable tint layer 82 may be layered directly onto cover layer 72.

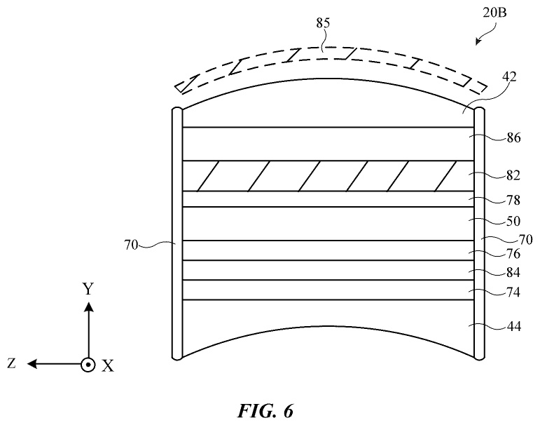

FIG. 5 is a cross-sectional side view showing how adjustable tint layer 82 may be layered directly onto cover layer 72. As shown in FIG. 5, air gap 80 (FIG. 4) may be omitted and adjustable tint layer 82 may be disposed or layered onto cover layer 72. When disposed in this way, air gap 86 remains interposed between adjustable tint layer 82 lens 42.

The example of FIGS. 4 and 5 in which cover layer 72 is interposed between lens 42 and waveguide 50 is merely illustrative. If desired, cover layer 72 may be omitted as shown in the cross-sectional side view of FIG. 6. As shown in FIG. 6, adjustable tint layer 82 may be mounted to support structure 70 at a location between lens 42 and waveguide 50 such that air gap 78 is interposed between waveguide 50 and adjustable tint layer 82 and such that air gap 86 is interposed between adjustable tint layer 82 and lens 42. If desired, adjustable tint layer 82 may help to protect waveguide 50 from contaminants or damage in this configuration (e.g., while optical system 20B exhibits less overall thickness in the Y dimension relative to examples where cover layer 72 is included in optical system 20B).

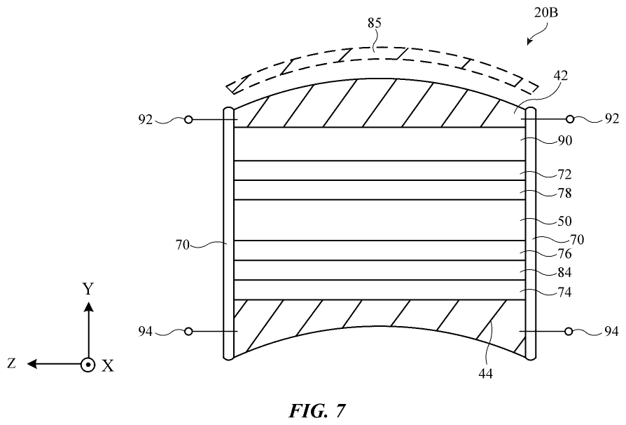

To further reduce the thickness of optical system 20B, lens 42 and/or lens 44 may be formed from adjustable tint material (e.g., lens 42 and/or lens 44 may themselves be adjustable tint layers such as adjustable tint layer 82 of FIGS. 3-6), as shown in the cross-sectional side view of FIG. 7. As shown in FIG. 7, lens 44 and/or lens 42 may be adjustable tint lenses (e.g., having one or more layers of adjustable tint material such as inorganic or organic EC layers or guest host liquid crystal layers, one or more transparent substrates, and two or more electrode layers). The electrode layers in lens 42 may receive control signals from control circuitry 16 (FIG. 1) that adjust the light transmission properties of lens 42 via terminals 92. The electrode layers in lens 44 may receive control signals from control circuitry 16 (FIG. 1) that adjust the light transmission properties of lens 44 via terminals 94.

The geometry of lens 44 may configure lens 44 to form a negative bias lens (e.g., imparting optical power to image light and world light) while lens 44 also performs adjustable tinting based on the control signals (voltages) provided over terminals 94. The geometry of lens 42 may configure lens 42 to form a positive bias lens (e.g., imparting optical power to world light) while lens 42 also performs adjustable tinting based on the control signals (voltages) provided over terminals 92. If desired, lens 42 may be an adjustable tint lens whereas lens 44 does not perform fixed and/or adjustable tinting.

The examples of FIGS. 4-7 are merely illustrative. Cover layer 84 may be omitted if desired. One or more additional tint layers may be incorporated into the examples of FIGS. 4-7 as described in connection with FIG. 3. For example, removable adjustable tint layer 85 may be provided on optical system 20B in the examples of FIGS. 4-7.

If desired, adjustable tint layer 82 of FIGS. 3-6 (or lenses 42/44 of FIG. 7) may be controlled/transitioned between multiple states (e.g., using control signals/voltages provided by control circuitry 16 of FIG. 1) each having different light transmission characteristics. For example, adjustable tint layer 82 of FIGS. 3-6 (or lenses 42/44 of FIG. 7) may be switched between a clear state that maximizes the transmission of light through the adjustable tint layer (e.g., when the user is viewing world light or when ambient light levels are relatively low) and a uniform dark state that minimizes the transmission of light through the adjustable tint layer (e.g., when the user is viewing display image light or when ambient light levels are relatively high). If desired, adjustable tint layer 82 of FIGS. 3-6 (or lenses 42/44 of FIG. 7) may also be switched into a gradient dark state in which different portions of the field of view are provided with a gradient of tinting.

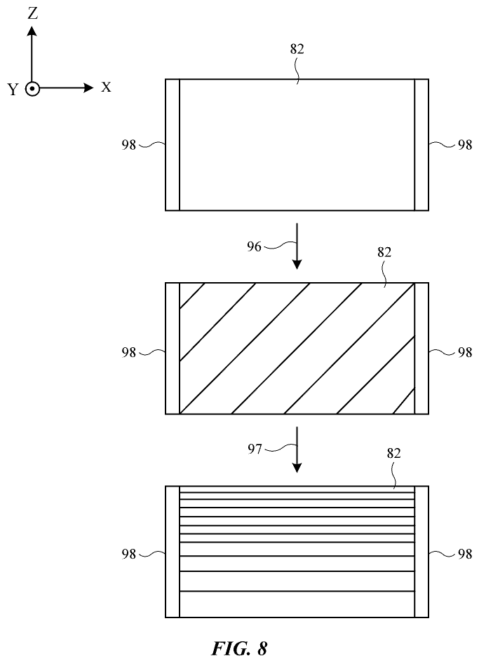

FIG. 8 is a front view showing how adjustable tint layer 82 may be transitioned between clear, uniform dark, and gradient dark states. As shown in FIG. 8, adjustable tint layer 82 may be provided with two or more electrodes such as electrodes 98 on opposing sides of the adjustable tint layer. While referred to in FIG. 8 as adjustable tint layer 82, adjustable tint layer 82 of FIG. 8 may include lens 42 and/or lens 44 of FIG. 7.

Control circuitry 16 (FIG. 1) may provide control signals (voltages) across electrodes 98 that place adjustable tint layer 82 in the clear state. This may maximize light transmission across the field of view of the eye box. Control circuitry 16 may change the voltage across electrodes 98 to place adjustable tint layer 82 in the uniform dark state, as shown by arrow 96. This may minimize light transmission across the field of view of the eye box.

Control circuitry 16 may control electrodes 98 along a given axis (e.g., the Z-axis of FIG. 8) to place adjustable tint layer 82 in the gradient dark state (sometimes referred to herein as the gradient state), as shown by arrow 97. In the gradient dark state, adjustable tint layer 82 may exhibit a gradient of light transmission (tint), such as a gradient from a first level at a first edge of the field of view to a second level at a second edge of the field of view. The gradient tint may be performed by changing tinting layer thickness along the direction of the gradient, by changing electrode resistance along the direction of the gradient, by providing multiple electrodes with different voltages along the direction of the gradient, etc. The gradient dark state may, for example, be used while system 10 is located outside to help prevent sunlight from reaching the eye box while still allowing the user to clearly view other real-world objects. The example of FIG. 8 in which the gradient extends along the Z-axis is merely illustrative and, in general, the gradient may be provided along any axis.

The example of FIG. 8 is merely illustrative and, if desired, adjustable tint layer 82 may have fewer than three states (e.g., the uniform dark or gradient dark states may be omitted) or may have more than three states with different light transmission characteristics. In addition to (or instead of) adjusting the level of light transmission, adjustable tint layer 82 may be controlled to impart a desired color tint or hue to the light transmitted through the adjustable tint layer to the eye box. If desired, the control circuitry may transition the adjustable tint layer through different states where the adjustable tint layer imparts a different desired color profile or hue to the transmitted light in each state.

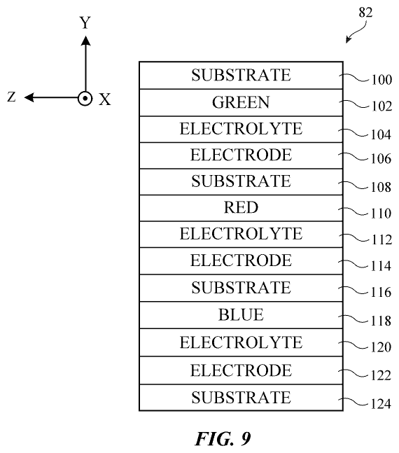

FIG. 9 is a cross-sectional side view showing one example of an adjustable tint layer 82 that may be placed into different states to impart different color profiles or hues to the light transmitted to the eye box. As shown in FIG. 9, adjustable tint layer 82 (e.g., adjustable tint layer 82 of FIGS. 3-6 or lenses 42/44 of FIG. 7) may include multiple layers sandwiched between transparent substrates such as substrates 100 and 124. For example, adjustable tint layer 82 may include a first tint material layer 102 (e.g., a layer of inorganic EC material, organic EC material, or a guest host liquid crystal layer) configured to transmit a first wavelength range or hue of incident light such as a green hue, a second tint material layer 110 (e.g., a layer of inorganic EC material, organic EC material, or a guest host liquid crystal layer) configured to transmit a second wavelength range or hue of incident light such as a red hue, and a third tint material layer 118 (e.g., a layer of inorganic EC material, organic EC material, or a guest host liquid crystal layer) configured to transmit a third wavelength range or hue of incident light such as a blue hue. Tint material layers 102, 110, and 118 may therefore sometimes be referred to herein as green layer 102, red layer 110, and blue layer 118. However, this is merely illustrative and, in general, layers 102, 110, and 118 may transmit light of any desired wavelength ranges.

Adjustable tint layer 82 may include a set of electrode layers such as electrodes 106, 114, and 122. Adjustable tint layer 82 may include electrolyte layers such as a first electrolyte layer 104 interposed between green layer 102 and electrode 106, a second electrolyte layer 112 interposed between red layer 110 and electrode 114, and a third electrolyte layer 120 interposed between blue layer 118 and electrode 122. If desired, adjustable tint layer 82 may include additional transparent substrate layers such as a substrate layer 108 interposed between electrode 106 and red layer 110 and a substrate layer 116 interposed between electrode 114 and blue layer 118. Electrodes 106, 114, and 122 may be, for example, counter electrodes.

Control circuitry 14 may provide control signals (voltages) to electrodes 106, 114, and 122 to transition adjustable tint layer 82 between different states in which the adjustable tint layer imparts a different hue to the transmitted light. For example, the control circuitry may place adjustable tint layer 82 into a uniform or gradient dark state in which green layer 102, red layer 110, and blue layer 118 uniformly combine to prevent the transmission of visible light through the adjustable tint layer. The control circuitry may place adjustable tint layer 82 into a clear state in which green layer 102, red layer 110, and blue layer 118 combine to uniformly transmit all wavelengths of visible light through the adjustable tint layer. The control circuitry may place adjustable tint layer 82 into a red state in which red layer 110 imparts a red hue to the transmitted light while green layer 102 and blue layer 118 are inactive, a blue state in which blue layer 118 imparts a blue hue to the transmitted light while red layer 110 and green layer 102 are inactive, a green state in which green layer 102 imparts a green hue to the transmitted light while red layer 110 and blue layer 118 are inactive, or other states in which the amount of light transmission of layers 102, 110, and 118 are varied to impart the transmitted light with different intensities at any desired range(s) of wavelengths.

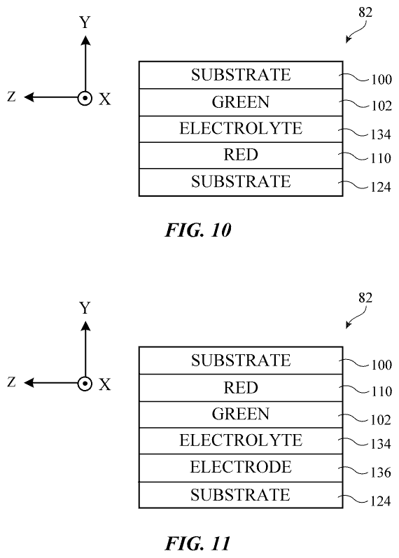

The example of FIG. 9 in which adjustable tint layer 82 includes three color layers for tuning the hue of transmitted light is merely illustrative. If desired, adjustable tint layer may include tandem color layers for tuning the hue of transmitted light, as shown in the examples of FIGS. 10 and 11. As shown in FIG. 10, adjustable tint layer 82 may include a first tint material layer (e.g., green layer 102), a second tint material layer (e.g., red layer 110), and an electrolyte layer 134 sandwiched between the first and second tint material layers all sandwiched between substrates 100 and 124. As shown in FIG. 11, adjustable tint material layer 82 may include a first tint material layer 110 (e.g., red layer 110), an electrolyte layer 134, a second tint material layer (e.g., green layer 102) sandwiched between red layer 110 and electrolyte layer 134, and an electrode 136 (e.g., where electrolyte layer 134 is sandwiched between green layer 102 and electrode 136), all sandwiched between substrates 100 and 124.

The examples of FIGS. 9-11 are merely illustrative. The adjustable tint material layers of FIGS. 9-11 may be disposed in other orders. Each adjustable tint material layer (e.g., layers 102, 110, and 118) may be configured to transmit light in any desired wavelength ranges. The color tinting of FIGS. 9-11 may be combined with the gradient tinting of FIG. 8 if desired. Adjustable tint layer 82 may include more than three layers of adjustable tint material if desired. In examples where optical system 20B includes multiple adjustable tint layers 82, each layer may include at least one respective adjustable tint layer that transmits a respective range of wavelengths (e.g., the functionality of adjustable tint layer 82 of FIG. 9 may be distributed across two or more adjustable tint layers 82 disposed at different locations in optical system 20B).

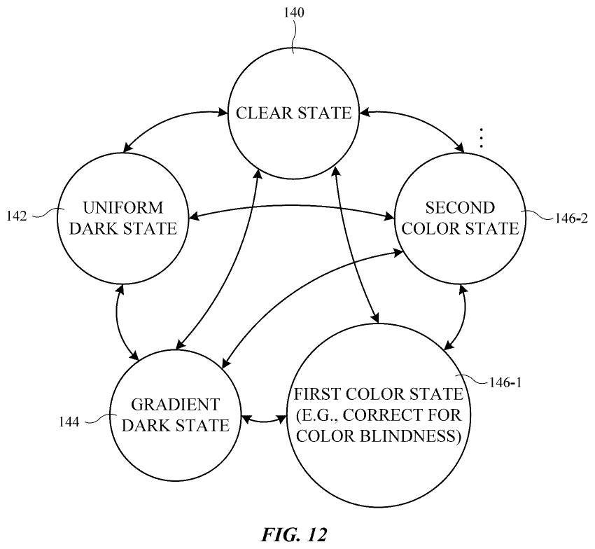

FIG. 12 is a state diagram showing how control circuitry 16 (FIG. 1) may transition adjustable tint layer 82 between different states each having a respective light transmission characteristic. As shown in FIG. 12, adjustable tint layer 82 may have at least a clear state (mode) 140, a uniform dark state (mode) 142, a gradient dark state (mode) 144, and a set of N color states 146 (e.g., a first color state 146-1, a second color state 146-2, etc.). If desired, one or more of the color states may also be operated in the gradient mode. The arrows of FIG. 12 illustrate potential transitions between the states. Control circuitry 16 may adjust the control signals provided to the electrodes on adjustable tint layer 82 to transition adjustable tint layer 82 between the different states.

In clear state 140, adjustable tint layer 82 may uniformly transmit as much light as possible across the wavelength ranges of its adjustable tint material layers (e.g., to allow the user to view real-world objects clearly). In uniform dark state 142, adjustable tint layer 82 may uniformly block as much light as possible across the wavelength ranges of its adjustable tint material layers (e.g., to allow the user to view virtual objects in image light clearly). In the gradient dark state 144, adjustable tint layer 82 may transmit light with a gradient in darkness/brightness across the field of view (e.g., as described in connection with FIG. 8).

In each color state 146, control circuitry 16 may configure each of the adjustable tint material layers within adjustable tint layer 82 (e.g., layers 102, 110, and 118 of FIGS. 9-11) to impart the light transmitted by adjustable tint layer 82 with a desired range of wavelengths (hues) (e.g., by transmitting different amounts of the light at different wavelengths). For example, in first color state 146-1, adjustable tint layer 82 may transmit more blue light than other colors (e.g., using blue layer 118 of FIG. 9), imparting the transmitted light with a blue hue, in second color state 146-2, adjustable tint layer 82 may transmit more red light than other colors (e.g., using red layer 110 of FIGS. 9-11), imparting the transmitted light with a red hue, etc. Control circuitry 16 may switch between the different colors based on the color temperature of ambient light (e.g., to provide the user with a particular hue of real-world light), based upon a user input (e.g., when the user wishes to use system 10 in a sunglasses function of a particular hue), etc.

If desired, one or more of color states 146 may configure adjustable tint layer 82 to correct for one or more different types of user colorblindness. This may allow system 10 to display color images that are properly perceived by different users having different colorblindness characteristics.

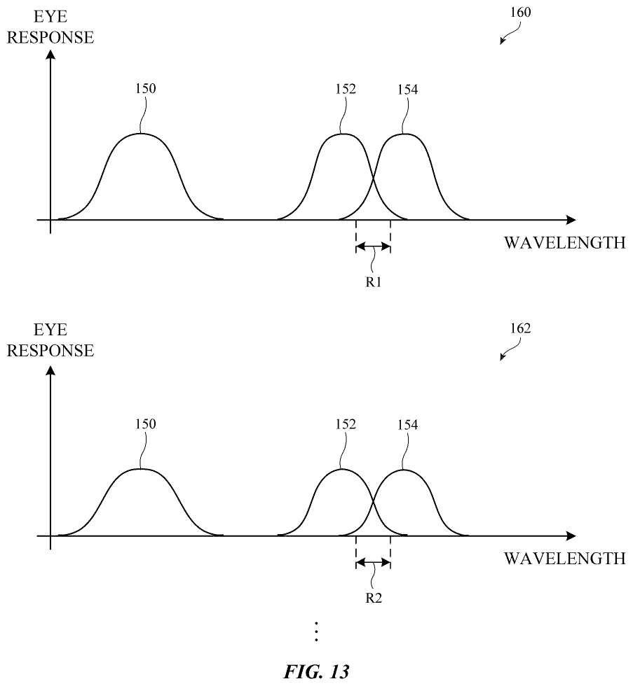

FIG. 13 includes plots showing how different color states may be used to mitigate different types of color blindness. Plot 160 plots the eye response of users with a first type of colorblindness whereas plot 162 plots the eye response of users with a second type of color blindness. Curve 150 plots the user's S-cone response, curve 152 plots the user's M-cone response, and curve 154 plots the user's L-cone response. Users having the first type of colorblindness may have an overlap between curves 152 and 154 within region R1 of plot 160 (e.g., thereby causing the user to confuse red and green light within region R1). To mitigate this type of color blindness, adjustable tint layer 82 may be placed in a color state 146 that filters out wavelengths of light within region R1, thereby allowing users with the first type of color blindness to properly view light from the display and world.

Users having the second type of colorblindness may have an overlap between curves 152 and 154 within region R2 of plot 160 that is different from region R1 (e.g., thereby causing the user to confuse red and green light within region R2). To mitigate this type of color blindness, adjustable tint layer 82 may be placed in a color state 146 that filters out wavelengths of light within region R2, thereby allowing users with the second type of color blindness to properly view light from the display and world. Light transmitted by two or more of the adjustable tint material layers (e.g., EC layers) of adjustable tint layer 82 may be mixed in first predetermined ratios to filter light within region R1 in a first color state 146 and may be mixed in second predetermined ratios to filter light within region R2 in a second color state 146. Additionally or alternatively, separate adjustable tint material layers of different colors may be activated on demand.

In this way, adjustable tint layer 82 may mitigate color blindness across a large range of users having different cone overlap characteristics. The EC color filter wavelength range can be individually tuned by changing the tint % of each individual tint material layer, for example. Filtering strength may be tuned by the EC switching process or entirely turned off if necessary. The example of FIG. 13 is merely illustrative. Adjustable tint layer 82 may be controlled to filter out any desired wavelength ranges to mitigate colorblindness.

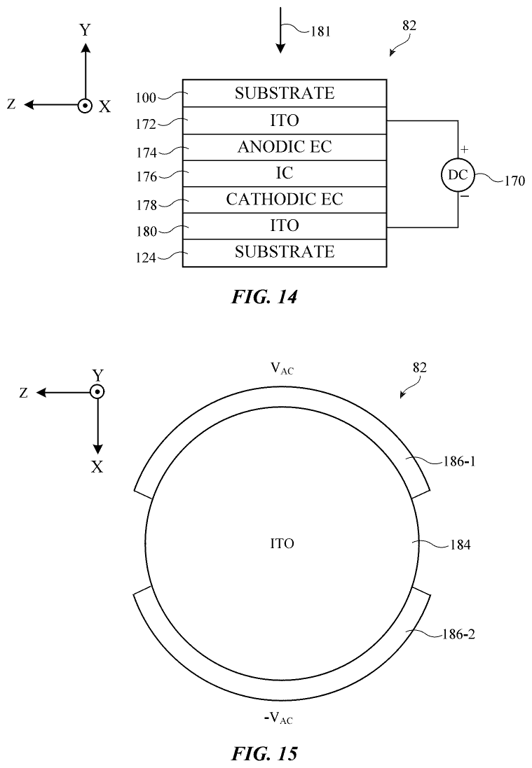

FIG. 14 is a cross-sectional side view showing how adjustable tint layer 82 (or lenses 42/44 of FIG. 7) may be switched between states (e.g., the states of FIG. 12) using a DC voltage. As shown in FIG. 14, adjustable tint layer 82 may include electrode layers such as ITO layer 172 on substrate 100 and ITO layer 180 on substrate 124. The layer of tint material in adjustable tint layer 82 may include anodic EC layer 174, ion conductor (IC) layer 176, and cathodic EC layer 178. Anodic EC layer 174 may be layered onto ITO layer 172. Cathodic EC layer 178 may be layered onto ITO layer 180. IC layer 176 may be sandwiched between cathodic EC layer 178 and anodic EC layer 174. A DC voltage 170 (e.g., control signals provided by control circuitry 16 of FIG. 1) may be applied across ITO layers 172 and 180. DC voltage 170 may be adjusted to switch adjustable tint layer 82 between different states. The example of FIG. 14 in which adjustable tint layer 82 includes a single layer of adjustable tint material is merely illustrative and, if desired, adjustable tint layer 82 may include multiple layers of adjustable tint material for controlling transmission of different wavelength ranges (e.g., as shown in FIGS. 9-11).

In general, electrochromic devices such as adjustable tint layer 82 exhibit faster switching speeds at higher operating temperatures. Adjustable tint layer 82 may be heated to increase the switching speed of the adjustable tint layer. While external heaters may be used to heat adjustable tint layer 82, external heaters can increase implementation cost and can cause excessive power consumption. To mitigate these issues, adjustable tint layer 82 may include structures that allow adjustable tint layer 82 to heat itself (e.g., adjustable tint layer 82 may be self-heating). For example, an AC voltage may be applied to adjustable tint layer 82 that produces resistive heating in the adjustable tint layer to maximize switching speed. The AC voltage may heat the adjustable tint layer independent of the switching performed by DC voltage 170.

FIG. 15 is a front view of adjustable tint layer 82 (e.g., as taken in the direction of arrow 181 of FIG. 14) showing one example of how an AC voltage may be applied to adjustable tint layer 82. As shown in FIG. 15, a set of conductive contacts 186 such as a first contact 186-1 and a second contact 186-2 may be disposed alone the periphery of ITO layer 184 in adjustable tint layer 82 (e.g., ITO layer 172 and/or ITO layer 180 of FIG. 14). Contacts 186-1 and 186-2 may be disposed at opposing sides of ITO layer 184. As an example, contacts 186 may include copper pads or other contact pads.

Contacts 186-1 and 186-2 may receive an AC voltage from control circuitry 16 (FIG. 1). For example, contact 186-1 may receive AC voltage V_{AC} while contact 186-2 receives an inverse AC voltage-V_{AC}. This AC voltage may produce resistive heating across ITO layer 184 without affecting the DC voltage used to switch the state of adjustable tint layer 82. The resistive heating may maximize the switching speed of adjustable tint layer 82. Additionally or alternatively, the AC voltage may be used to heat adjustable tint layer 82 to perform de-fogging of optical system 20B (e.g., to remove fog that has accumulated on waveguide 50, lens 42, lens 44, etc.).

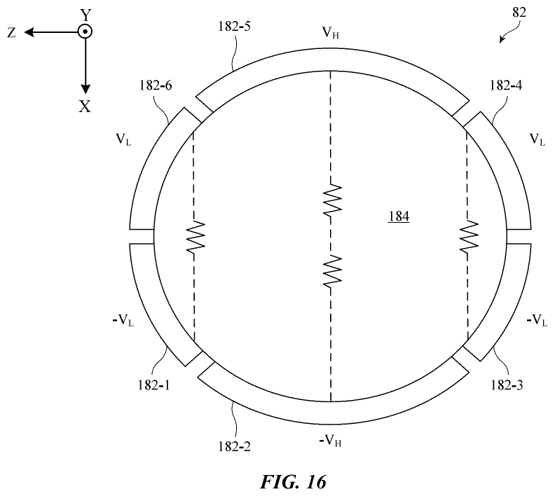

To further increase the uniformity with which ITO layer 184 is heated across its surface area, multiple AC voltages may be driven across ITO layer 184 as shown in the front view of FIG. 16. As shown in FIG. 16, adjustable tint layer 82 may include more than two contacts 182 such as contacts 182-1 through 182-6. Contact 182-5 may be disposed opposite contact 182-2 across the diameter of ITO layer 184. Contact 182-1 may be disposed opposite contact 182-6 across a distance less than the diameter of ITO layer 184. Contact 182-4 may be disposed opposite contact 182-3 across a distance less than the diameter of ITO layer 184.

In this example, contact 182-5 is located farther from contact 182-2 than contact 182-6 is from contact 182-1 and than contact 182-4 is from contact 182-3. ITO layer 184 may therefore exhibit greater resistance between contacts 182-5 and 182-2 than between contacts 182-6 and 182-1 and between contacts 182-4 and 182-3. To mitigate this variation in resistance, a first AC voltage V_{H} may be applied across contacts 182-5 and 182-2 while a second AC voltage V_{L} having a lower magnitude than AC voltage V_{H} is applied across contacts 182-6 and 182-1 and across contacts 182-4 and 182-3. The increased AC voltage applied across the diameter of ITO layer 184 may mitigate the increased resistance between contact pads 182-5 and 182-2 relative to the resistance between contacts 182-6 and 182-1 and between contacts 182-4 and 182-3. This may allow a uniform amount of resistive heating to be performed across the surface area of ITO layer 184. This uniform heating may help to maximize switching speed across the entire field of view and/or may allow for a uniform de-fogging pattern to be applied across the entire field of view, for example. The applied AC voltage has no impact on the DC voltage 170 (FIG. 14) used to switch adjustable tint layer 82. The example of FIG. 16 is merely illustrative and, in general, there may be any desired number of contacts 182 on ITO layer 184 for receiving one or more AC voltages.

If desired, adjustable tint layer 82 may be configured to form a self-switching EC device. While described herein in connection with adjustable tint layer 82, lenses 42/44 of FIG. 7 may similarly be configured to form a self-switching EC device. The self-switching EC device may have an auto-switching capability (e.g., for automatically switching between two or more of the states of FIG. 12) under sunlight. When configured as a self-switching electrochromic device, adjustable tint layer 82 may integrate and utilize a transparent solar cell that forms an internal power source for the adjustable tint layer. This allows adjustable tint layer 82 to be powered without an external power source (e.g., control circuitry 16), instead using solar light to power switches between states.

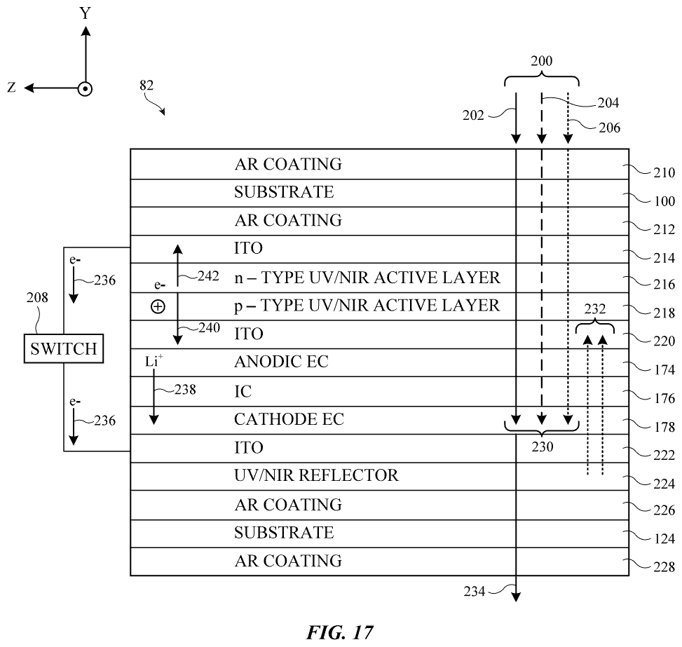

FIG. 17 is a cross-sectional side view showing one example of how adjustable tint layer 82 of FIGS. 3-6, 8-11, and 14-16 (or lenses 42/44 of FIG. 7) may be configured to form a self-switching EC device. As shown in FIG. 17, a first antireflective (AR) coating 210 may be layered onto a first surface of substrate 100. A second AR coating 212 may be layered onto a second surface of substrate 100. A third AR coating 226 may be layered onto a first surface of substrate 124. A fourth AR coating 228 may be layered onto a second surface of substrate 124. One or more of these AR coatings may be omitted if desired.

A transparent electrode layer such as ITO layer 214 may be layered onto AR coating 214. An n-type ultraviolet (UV)/near-infrared (NIR) active layer 216 may be layered onto ITO layer 214. A p-type UV/NIR active layer 218 may be layered on n-type UV/NIR active layer 216. An additional transparent electrode layer such as ITO layer 220 may be layered onto p-type UV/NIR active layer 218. An adjustable tint material layer having anodic EC layer 174, IC layer 176, and cathodic EC layer 178 may be layered onto ITO layer 220. A third transparent electrode layer such as ITO layer 222 may be layered on cathodic EC layer 178. A UV/NIR reflective layer 224 may be layered onto ITO layer 222. AR coating 224 may be layered onto UV/NIR reflector layer 224. A switch such as switch 208 may be coupled between ITO layer 214 and ITO layer 222 (e.g., using external wiring). This example is merely illustrative and, if desired, additional layers or fewer layers may be stacked into adjustable tint layer 82. The layers of adjustable tint layer 82 may be stacked in other orders if desired. The layers within adjustable tint layer 82 may sometimes also be referred to herein as coatings, films, or thin films.

In general, electrochromic (EC) materials can change their optical properties with electric potential (voltage). Light can thereby be modulated with electric field. Under a natural state, each of the films (layers) of adjustable tint layer 82 exhibit low absorption in visible light, making adjustable tint layer 82 appear transparent. However, when an external electric potential is applied, positive lithium (Li) ions flow from the anodic EC layer to the cathodic EC layer. Since IC layer 176 will block direct electron movement from the anodic EC layer to the cathodic EC layer, the electrons will flow from one electrode to the other electrode through an external conduction path. Since anodic EC materials absorb strongly in the visible range when losing positive Li ions (whereas cathodic EC materials will absorb strongly at visible wavelengths when binding positive Li ions), the whole device becomes dark in visible light under the electric potential.

However, such EC devices often require an external electric power source to perform light modulations (e.g., a power source in control circuitry 16 of FIG. 1). Such external power sources can increase implementation cost and/or power consumption, reducing battery life for system 10. The switching speed of EC devices can impose another limitation. In general, the switching speed doubles with every 10-degree Celsius increase in device temperature. However, adding external heating sources can also increase implementation cost and/or power consumption. To mitigate these issues, adjustable tint layer 82 may function as a self-switching EC device.

As shown in FIG. 17, a transparent solar cell is formed within adjustable tint layer 82 from n-type UV/NIR active layer 216, p-type UV/NIR active layer 218, and ITO layer 220, which forms a common transparent conductor between the transparent solar cell and the adjustable tint material layer formed from anodic EC layer 174, IC layer 176, and cathodic EC layer 178. N-type UV/NIR active layer 216 and p-type UV/NIR active layer 218 absorb light at UV and NIR wavelengths, which generates electrons and holes. AR coating layers 210, 212, 226, and 228 may minimize light reflections, thereby maximizing optical performance of the EC device in both clear and dark states. UV/NIR reflector layer 224 may reflect UV light and NIR light, to increase efficiency of the solar cell formed from layers 216-220. Substrates 100 and 124 may be transparent encapsulation substrates that minimize the impact of moisture on the adjustable tint layer, thereby maximizing reliability. IC layer 176 may serve to block the direct transfer of electrons from anodic EC layer 174 to cathodic EC layer 178, while also allowing positive ions to pass through during the switching process.

Sunlight 200 may be incident upon adjustable tint layer 82. Sunlight 200 may include visible light 202 at visible wavelengths, UV light 204 at UV wavelengths, and NIR light 206 at NIR wavelengths. Sunlight 200 may pass through the layers of adjustable tint layer 82 as shown by arrows 230. UV/NIR reflector layer 224 may reflect UV light 204 and NIR light 206 as shown by arrows 232, thereby optimizing the efficiency of the solar cell in adjustable tint layer 82.

In the clear state, switch 208 is open, inactive, or turned off (e.g., an open circuit or infinite impedance is interposed on the external conductive path between ITO layers 214 and 222). When switch 208 is open, visible light 202 may pass through EC devices and therefore passes through adjustable tint layer 82, as shown by arrow 234. However, UV light 204 and NIR light 206 may be absorbed in n-type UV/NIR active layer 216 and p-type UV/NIR active layer 218. Since there is no external current path between ITO layers 214 and 222 while switch 208 is open, the positive Li ions in anodic EC layer 174 cannot pass through IC layer 176. Both anodic EC layer 174 and cathodic EC layer 178 remain transparent to the visible spectrum. The absorption of UV/NIR light in layers 216 and 218 may dissipate as heat. This may allow the entire device to isolate heat from one side of the adjustable tint layer to the other. In addition, heat dissipation in layers 216 and 218 helps to warm layers 174, 176, and 178, thereby maximizing the switching speed of adjustable tint layer 82.

In the dark state, switch 208 is closed, active, or turned on (e.g., a closed circuit or zero impedance is interposed on the external conductive path between ITO layers 214 and 222). When switch 208 is closed, visible light 202 cannot pass through EC devices such as layers 174-178. UV light 204 and NIR light 206 are absorbed in layers 216 and 218, generating electrons and holes. As there is a direct current path between ITO layers 214 and 222 through switch 208 in this case, positive Li ions (Li⁺) in anodic EC layer 174 may pass through IC layer 176 into cathodic EC layer 178, as shown by arrow 238. The generated electrons (e⁻) pass from layers 216/218 into ITO layer 214 as shown by arrow 242, and through switch 208 to ITO layer 222 as shown by arrows 236. At the same time, the generated holes pass from layers 216/218 into ITO layer 220 as shown by arrow 240. Both anodic EC layer 174 and cathodic EC layer 178 will become strongly absorptive to visible light 202 in this configuration, preventing the visible light from passing through adjustable tint layer 82. In this way, adjustable tint layer 82 may function similar to a solar cell that generates electrons and holes using sunlight, where the electrons and holes charge the adjustable tint layer to switch itself to enter the dark state to block visible light transmission when needed. This may allow adjustable tint layer 82 to be switched without using an external power source, for example.

In accordance with an embodiment, an electronic device is provided that includes a projector configured to produce first light, a waveguide configured to propagate the first light via total internal reflection, an output coupler configured to couple the first light out of the waveguide and configured to transmit second light from a scene, a bias lens configured to impart an optical power to the second light, and an electrically adjustable light modulator between the bias lens and the waveguide and configured to transmit the second light from the bias lens to the output coupler, the electrically adjustable light modulator is separated from the bias lens by an air gap.

In accordance with another embodiment, the electrically adjustable light modulator includes an adjustable tint layer.

In accordance with another embodiment, the adjustable tint layer includes a layer selected from the group consisting of an organic electrochromic layer, an inorganic electrochromic layer, and a guest host liquid crystal layer.

In accordance with another embodiment, the electronic device includes a cover layer interposed between the waveguide and the electrically adjustable light modulator, the cover layer being separated from the waveguide by a first additional air gap and being separated from the electrically adjustable light modulator by a second additional air gap.

In accordance with another embodiment, the electronic device includes a cover layer interposed between the waveguide and the electrically adjustable light modulator, the cover layer being separated from the waveguide by an additional air gap and the electrically adjustable light modulator being layered onto the cover layer.

In accordance with another embodiment, an additional air gap separates the electrically adjustable light modulator from the waveguide.

In accordance with another embodiment, the electronic device includes an additional electrically adjustable light modulator configured to transmit the second light, the bias lens is interposed between the electrically adjustable light modulator and the additional electrically adjustable light modulator.

In accordance with another embodiment, the bias lens includes an additional electrically adjustable light modulator.

In accordance with another embodiment, the electrically adjustable light modulator is adjustable between a clear state, a uniform dark state, and a gradient dark state.

In accordance with another embodiment, the electrically adjustable light modulator is adjustable between a first state in which the electrically adjustable light modulator imparts a first color tint onto the second light and a second state in which the electrically adjustable light modulator imparts a second color tint onto the second light, the second color tint being different from the first color tint.

In accordance with another embodiment, the first color tint is configured to mitigate a first type of colorblindness and the second color tint is configured to mitigate a second type of colorblindness different from the first type of colorblindness.

In accordance with another embodiment, the electrically adjustable light modulator includes at least two contact pads configured to receive one or more alternating current voltages that resistively heat the electrically adjustable light modulator.

In accordance with another embodiment, the electrically adjustable light modulator includes a self-switching electrochromic device.

In accordance with another embodiment, the self-switching electrochromic device includes a transparent solar cell.

In accordance with an embodiment, an electronic device is provided that includes a projector configured to produce first light, a waveguide configured to propagate the first light via total internal reflection, an output coupler configured to couple the first light out of the waveguide and configured to transmit second light from a scene, and a bias lens configured to impart an optical power to the second light, the bias lens includes an electrically adjustable light modulator that is switchable between at least a first state in which the bias lens transmits the second light to the output coupler and a second state in which the bias lens blocks the second light from passing to the output coupler.

In accordance with another embodiment, the electronic device includes an additional bias lens configured to at least partially reverse the optical power imparted to the second light by the bias lens, the waveguide is interposed between the bias lens and the additional bias lens.

In accordance with another embodiment, the additional bias lens includes an additional electrically adjustable light modulator.

In accordance with another embodiment, the electrically adjustable light modulator has a third state in which the bias lens transmits the second light with a first hue and a fourth state in which the bias lens transmits the second light with a second hue different from the first hue.

In accordance with another embodiment, the electrically adjustable light modulator includes a first layer of electrochromic material and a second layer of electrochromic material that is different from the first layer of electrochromic material.

In accordance with an embodiment, a display is provided that includes a projector configured to produce first light, a waveguide configured to propagate the first light via total internal reflection, an output coupler configured to couple the first light out of the waveguide and configured to transmit second light from external to the display, and an electrically adjustable light modulator that is adjustable between first and second states using a direct current (DC) voltage, in the first state the electrically adjustable light modulator is configured to transmit the second light to the output coupler and in the second state the electrically adjustable light modulator is configured to block the second light from passing to the output coupler, and the electrically adjustable light modulator includes an indium tin oxide (ITO) layer having a contact configured to receive an alternating current (AC) voltage that resistively heats the electrically adjustable light modulator.

In accordance with another embodiment, the AC voltage has a first magnitude and the ITO layer has an additional contact configured to receive an additional AC voltage having a second magnitude that is less than the first magnitude.

In accordance with an embodiment, a display is provided that includes a projector configured to produce first light, a waveguide configured to propagate the first light via total internal reflection, an output coupler configured to couple the first light out of the waveguide and configured to transmit second light from external to the display, and a self-switching electrochromic device that is configured to transmit the second light to the output coupler.

In accordance with another embodiment, the self-switching electrochromic device has a plurality of states and the self-switching electrochromic device is configured to transmit a different respective amount of the second light to the output coupler in each state of the plurality of states.

In accordance with another embodiment, the self-switching electrochromic device includes a transparent solar cell.

In accordance with another embodiment, the self-switching electrochromic device includes an anodic electrochromic layer, an ion conductor layer, and a cathodic electrochromic layer, and the transparent solar cell includes an indium tin oxide (ITO) layer on the anodic electrochromic layer.

In accordance with another embodiment, the transparent solar cell includes an n-type active layer and a p-type active layer.

In accordance with another embodiment, the self-switching electrochromic device includes a first additional ITO layer on the transparent solar cell, a second ITO layer on the cathodic electrochromic layer, and a switch that couples the first additional ITO layer to the second additional ITO layer.

In accordance with another embodiment, the display includes an ultraviolet and near-infrared reflector layer on the second additional ITO layer.

The foregoing is merely illustrative and various modifications can be made to the described embodiments. The foregoing embodiments may be implemented individually or in any combination.

What is claimed is:

1. An electronic device comprising:
a projector configured to produce first light;
a waveguide configured to propagate the first light via total internal reflection;
an output coupler configured to couple the first light out of the waveguide and configured to transmit second light from a scene;
a bias lens configured to impart an optical power to the second light; and
an electrically adjustable light modulator between the bias lens and the waveguide and configured to transmit the second light from the bias lens to the output coupler, wherein the electrically adjustable light modulator is separated from the bias lens by an air gap.

2. The electronic device of claim 1, wherein the electrically adjustable light modulator comprises an adjustable tint layer.

3. The electronic device of claim 2, wherein the adjustable tint layer comprises a layer selected from the group consisting of: an organic electrochromic layer, an inorganic electrochromic layer, and a guest host liquid crystal layer.

4. The electronic device of claim 1, further comprising:
a cover layer interposed between the waveguide and the electrically adjustable light modulator, the cover layer being separated from the waveguide by a first additional air gap and being separated from the electrically adjustable light modulator by a second additional air gap.

5. The electronic device of claim 1, further comprising:
a cover layer interposed between the waveguide and the electrically adjustable light modulator, the cover layer being separated from the waveguide by an additional air gap and the electrically adjustable light modulator being layered onto the cover layer.

6. The electronic device of claim 1, wherein an additional air gap separates the electrically adjustable light modulator from the waveguide.

7. The electronic device of claim 1, further comprising:
an additional electrically adjustable light modulator configured to transmit the second light, wherein the bias lens is interposed between the electrically adjustable light modulator and the additional electrically adjustable light modulator.

8. The electronic device of claim 1, wherein the bias lens comprises an additional electrically adjustable light modulator.

9. The electronic device of claim 1, wherein the electrically adjustable light modulator is adjustable between a clear state, a uniform dark state, and a gradient dark state.

10. The electronic device of claim 1, wherein the electrically adjustable light modulator is adjustable between a first state in which the electrically adjustable light modulator imparts a first color tint onto the second light and a second state in which the electrically adjustable light modulator imparts a second color tint onto the second light, the second color tint being different from the first color tint.

11. The electronic device of claim 10, wherein the first color tint is configured to mitigate a first type of colorblindness and the second color tint is configured to mitigate a second type of colorblindness different from the first type of colorblindness.

12. The electronic device of claim 1, wherein the electrically adjustable light modulator comprises at least two contact pads configured to receive one or more alternating current voltages that resistively heat the electrically adjustable light modulator.

13. The electronic device of claim 1, wherein the electrically adjustable light modulator comprises a self-switching electrochromic device.

14. The electronic device of claim 13, wherein the self-switching electrochromic device comprises a transparent solar cell.

15. An electronic device comprising:
a projector configured to produce first light;
a waveguide configured to propagate the first light via total internal reflection;
an output coupler configured to couple the first light out of the waveguide and configured to transmit second light from a scene; and
a bias lens configured to impart an optical power to the second light, wherein the bias lens comprises an electrically adjustable light modulator that is switchable between at least a first state in which the bias lens transmits the second light to the output coupler and a second state in which the bias lens blocks the second light from passing to the output coupler.

16. The electronic device of claim 15, further comprising:
an additional bias lens configured to at least partially reverse the optical power imparted to the second light by the bias lens, wherein the waveguide is interposed between the bias lens and the additional bias lens.

17. The electronic device of claim 16, wherein the additional bias lens comprises an additional electrically adjustable light modulator.

18. The electronic device of claim 15, wherein the electrically adjustable light modulator has a third state in which the bias lens transmits the second light with a first hue and a fourth state in which the bias lens transmits the second light with a second hue different from the first hue.

19. The electronic device of claim 18, wherein the electrically adjustable light modulator comprises a first layer of electrochromic material and a second layer of electrochromic material that is different from the first layer of electrochromic material.

20. A display comprising:
a projector configured to produce first light;
a waveguide configured to propagate the first light via total internal reflection;
an output coupler configured to couple the first light out of the waveguide and configured to transmit second light from external to the display; and
an electrically adjustable light modulator that is adjustable between first and second states using a direct current (DC) voltage, wherein in the first state the electrically adjustable light modulator is configured to transmit the second light to the output coupler and in the second state the electrically adjustable light modulator is configured to block the second light from passing to the output coupler, and wherein the electrically adjustable light modulator comprises:
an indium tin oxide (ITO) layer having a contact configured to receive an alternating current (AC) voltage that resistively heats the electrically adjustable light modulator.

21. The display of claim 20, wherein the AC voltage has a first magnitude and the ITO layer has an additional contact configured to receive an additional AC voltage having a second magnitude that is less than the first magnitude.

22. A display comprising:
a projector configured to produce first light;
a waveguide configured to propagate the first light via total internal reflection;
an output coupler configured to couple the first light out of the waveguide and configured to transmit second light from external to the display; and
a self-switching electrochromic device that is configured to transmit the second light to the output coupler.

23. The display of claim 22, wherein the self-switching electrochromic device has a plurality of states and wherein the self-switching electrochromic device is configured to transmit a different respective amount of the second light to the output coupler in each state of the plurality of states.

24. The display of claim 22, wherein the self-switching electrochromic device comprises a transparent solar cell.

25. The display of claim 24, wherein the self-switching electrochromic device comprises an anodic electrochromic layer, an ion conductor layer, and a cathodic electrochromic layer, and wherein the transparent solar cell comprises an indium tin oxide (ITO) layer on the anodic electrochromic layer.

26. The display of claim 25, wherein the transparent solar cell further comprises an n-type active layer and a p-type active layer.

27. The display of claim 26, the self-switching electrochromic device further comprising:
a first additional ITO layer on the transparent solar cell;
a second ITO layer on the cathodic electrochromic layer; and
a switch that couples the first additional ITO layer to the second additional ITO layer.

28. The display of claim 27, further comprising an ultraviolet and near-infrared reflector layer on the second additional ITO layer.
